(19) United States
(12) Patent Application Publication
(10) Pub. No.: US 2026/0243626 A1
(43) Pub. Date: Aug. 20, 2026

(54) TEST STAND FOR TESTING AN ELECTRICALLY DRIVABLE AXLE MODULE FOR A MOTOR VEHICLE, AND MODULAR SYSTEM

(71) Applicant: ZF Friedrichshafen AG, Friedrichshafen (DE)

(72) Inventor: Christian Hell, Untergriesbach (DE)

(73) Assignee: ZF Friedrichshafen AG, Friedrichshafen (DE)

(21) Appl. No.: 18/852,686

(22) PCT Filed: Mar. 31, 2023
(86) PCT No.: PCT/EP2023/058443

§ 371 Date: Sep. 30, 2024

(30) Foreign Application Priority Data
Apr. 1, 2022 (DE) 10 2022 203 236.5

(51) Int. Cl. G01M 13/025

(52) U.S. Cl. CPC G01M 13/025

(57) ABSTRACT

A test stand and modular system are provided for testing an electrically drivable axle module of a motor vehicle having first and second drive output shafts. The test stand has a first loading motor with a first motor shaft, a second loading motor with a second motor shaft, and a test stand base with a test object holder for holding the axle module. The first motor shaft can be connected with no transmission ratio to the first drive output shaft and the second motor shaft can be connected with no transmission ratio to the second drive output shaft. The first and second loading motors are each in the form of permanently excited synchronous motors with at least twelve magnetic pole pairs. The first and second loading motors are each arranged on respective sliding carriages on the test stand base and can be moved toward the axle module.

### RELATED APPLICATIONS

This application claims the benefit under 35 U.S.C. § 371 as a U.S. National Phase Application of application no. PCT/EP2023/058443, filed on 31 Mar. 2023, which claims the benefit of German Patent Application no. 10 2022 203 236.5 filed on 1 Apr. 2022, the contents of which are hereby incorporated herein by reference in their entireties.

### FIELD OF THE DISCLOSURE

The invention relates to a test stand for testing an electrically drivable axle module for a motor vehicle, and to a corresponding modular system.

### SUMMARY

Test stands for testing motor vehicle transmissions and drivetrain test stands for testing complete motor vehicle drivetrains are known from the prior art. For example, such test stands can be used for quality-control purposes, such as for recognizing functional defects in drivetrains at an early stage by means of a series of loading tests. Typical functional defects occur for example due to components affected by play, such as gearwheels, synchronizer rings, synchronizer bodies, disk clutch disks and shafts that are deflected and can be excited into vibrations. As part of such a quality-control process, as a rule, the acoustic behavior and the shifting quality are also tested. Likewise, however, such test stands are also used in development processes and for the continual improvement of motor vehicle drivetrains.

In this connection DE 43 28 537 C2 describes a transmission test stand with a first servomotor that serves as a drive motor and a second servomotor that serves as a braking motor. The drive motor is connected by way of a clutch to the drive input shaft of a motor vehicle transmission to be tested, and among other things its rotation speed is controlled by a PC so that any desired rotation speed variations can be simulated. The braking motor is connected by way of a further clutch to a drive output shaft of the motor vehicle transmission to be tested. The rotation speed of the braking motor is also controlled by the PC. The rotation speed variations simulated by the PC are rotation speed variations measured in real driving tests. Thus, according to DE 43 28 537 C2 the motor vehicle drivetrain can be tested before being fitted into a motor vehicle.

DE 103 28 461 A1 discloses a vehicle test stand with a loading machine for each drivable wheel of a motor vehicle. In this case, the loading machines are connected to the wheel rims of the motor vehicle wheels either directly, for example by means of wheel bolts, or indirectly, for example by a belt drive, so that the loading machines can both drive and also brake the drivetrain. The vehicle test stand of DE 103 28 461 A1 also comprises a frame structure by which the motor vehicle and the loading machines can be raised and orientated relative to one another. During the testing process the motor vehicle is supported completely by the frame structure, so the vehicle wheels are not in contact with the ground.

### SUMMARY

However, the known motor vehicle test stands have disadvantages for several reasons. For one thing they are comparatively large and therefore require a comparatively large area in which to set them up. Furthermore, the force flow from the loading motors into the base of the test stand is not ideal.

An objective of the present invention is to propose an improved test stand for testing an electrically drivable axle module for a motor vehicle.

According to the invention this objective is achieved by the test stand for testing an electrically drivable axle module for a motor vehicle as disclosed herein. Advantageous design features will be apparent in light of the present disclosure.

The invention relates to a test stand for testing an electrically drivable axle module for a motor vehicle, comprising at least a first loading motor and a second loading motor and a test stand base with a test object holder that receives the axle module, wherein a first motor shaft of the first loading motor can be connected with no transmission ratio to a first drive output shaft of the axle module and a second motor shaft of the second loading motor can be connected with no transmission ratio to a second drive output shaft of the axle module, and wherein the first loading motor and the second loading motor are each in the form of permanently excited synchronous motors with at least twelve magnetic pole pairs.

The test stand according to the invention is characterized in that the first loading motor is arranged on a sliding carriage on the test stand base so that it can be moved toward the axle module and the second loading motor is arranged on a sliding carriage on the test stand base so that it can be moved toward the axle module.

Thus, the invention describes a test stand which is suitable for testing an electrically driven axle module for a motor vehicle, which besides the electric drive motor, usually requires a transmission and two wheel shafts.

The test stand according to the invention comprises at least a first loading motor and a second loading motor which are in the form of electric motors, namely permanently excited synchronous motors with at least twelve magnetic pole pairs.

Electric motors as such are generally already comparatively compact and in particular, compared with internal combustion engines, they have a broad rotation speed spectrum and advantageously deliver their maximum torque over a wide range.

The synchronous motors described, with at least twelve magnetic pole pairs, are in particular also called synchro-torque motors. They have the advantage that the loading motors are particularly compact and, especially, axially short and slow-rotating, but during this they can deliver a large torque. For example, the first and second loading motors can run at rotation speeds up to 3,000 rpm.

Each loading motor comprises a respective motor housing which accommodates the loading motor. The motor housings are for example cylindrical.

The motor housings can also be water-cooled.

Advantageously, an inverter of its own is associated with each loading motor. The inverters are for example of three-phase design.

The first loading motor has a first motor shaft and the second motor has a second motor shaft, wherein the first motor shaft can be connected to a first drive output shaft of the axle module to be tested and likewise the second motor shaft can be connected to the second drive output shaft of the axle module. In this case the connection is in the form of a rotationally fixed driving connection with no transmission ratio.

A connection with no transmission ratio in the context of the invention is understood to mean a connection without any intermediately connected gear ratio or transmission, so that there is no rotation speed step-up or step-down. Accordingly, the test stand according to the invention is made without a comparatively expensive transmission or a corresponding transmission ratio to step down the motor rotation speed, and this substantially reduces the fitting space required and the production costs.

By dispensing with the transmission for stepping-down the rotation speed of the first and second loading motors, besides the transmissions themselves, there is also no need for the otherwise necessary connecting means of the first and second loading motors, such as corresponding clutches. Furthermore, no mechanical protective precautions for covering the rapidly rotating connecting means have to be provided.

A further advantage arising from the omission of transmissions is that no shifting processes for adapting the rotation speeds or torques are necessary and accordingly a steady and continuous loading of the axle module without shift interruptions can take place.

Since the transmissions of similar test stands are as a rule shifted pneumatically or hydraulically, it is also advantageously possible to do without a corresponding pneumatic or hydraulic system.

In the context of the invention, a driving connection is understood to mean a mechanical connection for the transmission of mechanical power. The mechanical connection can be direct, or it can also comprise intermediate shafts, for example.

The first drive output shaft and the second drive output shaft of the axle module are typically the first wheel shaft and the second wheel shaft of the axle module, which during the operation of the axle module are acted upon via a transmission of the axle module by an electric drive motor with a torque and a rotation speed.

By virtue of the driving connection of the first drive output shaft with the first motor shaft and the second drive output shaft with the second motor shaft, it is also possible for torques and rotation speeds produced by the first and second loading motors to be passed into the axle module, so that the axle module can be acted upon, i.e., loaded, by the torques and rotation speeds. In each case, the torque and the rotation speed together constitute a mechanical power with which the axle module is correspondingly loaded.

The test stand also comprises a test stand base with a test object holder in order receive the axle module. By virtue of the test object holder the axle module can be arranged on the test stand and can therefore undergo a testing procedure.

In this context, the test stand base is the element on which all the other parts of the test stand are arranged. Thus, the test stand base orders all the other parts of the test stand and holds them in the correct positions. Accordingly, at least in a figurative sense, the test stand base constitutes a kind of scaffold or frame on which the other parts of the test stand are arranged.

Advantageously, the test stand consists at least in part of a particularly rigid material such as a cast mineral composite, in particular with a metallic skeleton structure. Owing to the compact configuration of the first and second loading motors and the omission of the transmission, in particular the test stand base can be made substantially smaller which in turn also results in considerable cost savings in that area too.

According to the invention, it is now provided that the first loading motor is arranged on a first sliding carriage and can be moved toward the axle module, and the second loading motor is arranged on a second sliding carriage and can be moved toward the axle module.

Thus, the first loading motor is arranged on a first sliding carriage and the second loading motor is arranged on a second sliding carriage. The first and second loading motors are therefore arranged so that they can move on the test stand base, for example along a rail, so that when necessary they can be brought up to the axle module, i.e., moved toward the axle module or away from the axle module. In that way, in a simple manner the driving connection of the first motor shaft to the first drive output shaft can be made and unmade again and the driving connection of the second motor shaft to the second drive output shaft can be made and unmade again. The fitting of the axle module onto the test stand is also greatly simplified thereby.

According to a preferred embodiment of the invention, it is provided that the test stand also comprises a drive motor and that a drive motor shaft of the drive motor can be connected to an input shaft of the axle module. This has the advantage that in such a case the axle module is not driven by a drive motor of its own dedicated to and associated with the axle module, but instead a drive motor associated with the test stand and connected to the test stand base is used for testing the axle module, which as a rule enables comparatively more extensive and more intense testing.

Advantageously, the drive motor is arranged on a third sliding carriage analogously with the first and second loading motors. This third sliding carriage can also be moved toward the axle module, for example since it too is arranged movably on a rail.

The drive motor too is in the form of a synchro-torque motor with at least twelve magnetic pole pairs. Preferably, a three-phase inverter is again associated with the drive motor.

Preferably, a motor shaft of the drive motor can be connected rotationally fixed and with no transmission ratio to an input shaft of the axle module.

In a further preferred embodiment of the invention, it is provided that the first sliding carriage is in the form of a first clamping angle and the second sliding carriage is in the form of a second clamping angle. A clamping angle is understood to mean that in essence there are two surfaces at a right-angle, i.e., perpendicular to one another, of which a first surface serves to support the loading motor concerned, for example by means of a motor holder, while a second surface serves to be displaceable by way of a rail over the base of the test stand.

Advantageously, the first and second clamping angles are made of steel. Besides the two surfaces that form the angle which gives it its name, they can also comprise additional stiffening braces that connect the first and second surfaces to one another and thus strengthen the whole.

In a further preferred embodiment of the invention, it is provided that the first loading motor is arranged with an end adjacent to a motor holder of the first sliding carriage and the second loading motor is arranged with an end adjacent to a motor holder of the second sliding carriage. For that purpose, the first and the second sliding carriages have, respectively, a first motor holder and a second motor holder.

This design makes for a comparatively large contact area between the first and second loading motors and their respective sliding carriages. That in turn results in comparatively high rigidity, so that during a testing process the occurrence of vibrations can be effectively suppressed in the area of the loading motors. This manner of connecting the loading motors has the further advantage that torques or forces produced can be transmitted into the first and second sliding carriages and from there into the base of the test stand. This results in a more clear force flow. The end of the first and second loading motors by which the first and second loading motors are held onto the basic frame are preferably the so-termed a-side of the loading motors.

Preferably, the first and second motor holders consist of a flange connection in each case. A first part of the flange connection is the end of the loading motor concerned or the end of its housing, and a second part consists of the corresponding motor holder on the sliding carriage concerned.

Thanks to the possibility of arranging the first and second loading motors on the base of the test stand by means of a flange connection, the test stand according to the invention can also be refitted comparatively simply for different loading intensities since loading motors of higher or lower power category can be fitted onto the basic frame. Advantageously, all loading motors of the different power categories have a standard flange interface.

According to a further preferred embodiment of the invention, it is provided that the test stand comprises a module for the vertical adjustment of the first loading motor and/or of the second loading motor and/or of the drive motor. The vertical adjustment module advantageously allows the first or second loading motor and the drive motor to be adjusted vertically so as to align them vertically with the drive output shaft of the axle module concerned, and thus to produce a driving connection between the first or second loading motor or the drive motor and the axle module.

Since the vertical adjustment module is available, the first or second loading motor or the drive motor can advantageously be adjusted vertically in a simple manner and in particular continuously. Thus, in particular it is not necessary to release the first or second loading motor or the drive motor from the motor holder and then adjust it vertically as required, for example by means of other, correspondingly offset screw connections, on the motor holder.

In a particularly preferred embodiment of the invention, it is provided that the vertical adjustment module comprises a first plate and a second plate, wherein the first plate and the second plate are arranged in an overlapping manner and wherein the first and second plates can be adjusted vertically relative to one another.

The first plate for example comprises the motor holder, particularly in the form of a circle of holes in the flange connection. The second plate of the vertical adjustment module can for example be connected directly to the clamping angle, for example also by a flange connection.

Advantageously, the first and second plates of the vertical adjustment module also comprise at least one vertical guide rail along which the first plate can be adjusted vertically relative to the second plate.

The first and second plates of the vertical adjustment module can for example be adjusted relative to one another manually by means of a screw drive, or automatically by an actuator.

According to a further preferred embodiment of the invention, it is provided that the first motor shaft is connected via a first connecting shaft, with no clutch and rotationally fixed, to the first drive output shaft, and the second motor shaft is connected via a second connecting shaft, with no clutch and rotationally fixed, to the second drive output shaft. Thus, the first connecting shaft directly connects the first drive output shaft to the first motor shaft and, likewise, the second connecting shaft directly connects the second drive output shaft to the second motor shaft. Since no clutches are involved, the connections of the motor shafts to the drive output shafts are comparatively short and therefore torsionally rigid, which in turn prevents the occurrence of torsional vibrations. Furthermore, there are no additional masses in the drivetrain, so that correspondingly no imbalances related thereto can occur.

Preferably, it is also provided that the motor shaft of the drive motor as well is connected by a corresponding connecting shaft, with no clutch and rotationally fixed, to the input shaft of the axle module.

In a further preferred embodiment of the invention, it is provided that the first motor shaft is connected rotationally fixed by way of a first torque sensor to the first connecting shaft and the second motor shaft is connected rotationally fixed by way of a second torque sensor to the second connecting shaft.

Thus, the first and second torque sensors in each case constitute connecting elements via which the first and second motor shafts are connected rotationally fixed to the respective first and second connecting shafts.

In that way the torques delivered by the loading motors are transmitted in full via the first and second torque sensors. The torque sensors therefore detect the torques delivered in full.

The first and second torque sensors preferably each comprise one or more force-sensitive elements, in particular one or more strain gauges, which first detect a force or forces that act upon the force-sensitive element or the plurality of force-sensitive elements. By virtue of the geometry of the torque sensors it is then possible from the force or forces detected to determine the torque acting in each case.

In an analogous manner, the motor shaft of the drive motor can advantageously also be connected to the connecting shaft of the drive motor via a torque sensor.

According to a further preferred embodiment of the invention, it is provided that the first connecting shaft is in the form of a universal joint shaft and the second connecting shaft is also in the form of a universal joint shaft. This has the advantage that the first loading motor does not have to be precisely aligned with the first drive output shaft and correspondingly also the second loading motor does not have to be precisely aligned with the second drive output shaft, since to a certain extent offset angles can be aligned by the respective universal joint shafts. This simplifies and speeds up the fitting of the axle module into the test stand.

Analogously, the connecting shaft of the drive motor to the input shaft of the axle module can advantageously be in the form of a universal joint shaft.

In another preferred embodiment of the invention, it is provided that the first motor shaft is in the form of a hollow shaft and the first torque sensor is arranged at an end of the first loading motor facing away from the axle module, and/or the second motor shaft is in the form of a hollow shaft and the second torque sensor is arranged at an end of the second loading motor facing away from the axle module. In this case the first connecting shaft can be passed through the first motor shaft in the form of a hollow shaft and connected rotationally fixed to the first connecting shaft on the b-side of the first loading motor via the first torque sensor. Likewise, the second connecting shaft can be passed through the second motor shaft in the form of a hollow shaft and connected rotationally fixed to the second connecting shaft on the b-side of the second loading motor via the second torque sensor.

Analogously, the motor shaft of the drive motor can advantageously be in the form of a hollow shaft and the torque sensor of the drive motor can be arranged at an end of the drive motor facing away from the axle module.

According to a very particularly preferred embodiment of the invention, it is provided that the first torque sensor is arranged on an end of the first loading motor facing away from the test object and/or that the second torque sensor is arranged on an end of the second loading motor facing away from the test object. In other words, this means that the first torque sensor is arranged on the so-termed b-side of the first loading motor and the second torque sensor is arranged correspondingly on the b-side of the second loading motor.

Preferably, it is provided that a rotation speed of the first loading motor, the second loading motor and the drive motor are detected in each case, for example by their control electronics and in particular by means of their inverter. From the known rotation speed and the known torque, for example the mechanical power acting upon the axle module can then be determined.

The invention also relates to a modular system for the simple production of a test stand adapted for the test object, comprising at least a first loading motor and a second loading motor, each of a common power category, and at least a first inverter and a second inverter, each of a common power category, wherein the common power category of the at least first and second inverters corresponds to the power category of the at least first and second electric motors. In addition, the modular system comprises a first sliding carriage and a second sliding carriage and a test stand base.

Thus, the modular system enables the production of a test stand according to the invention and includes all the constituents of the test stand according to the invention. Furthermore, the modular system, if necessary, includes a plurality of first and second loading motors and a plurality of first and second inverters assigned in pairs to a power category. In that way, for example, depending on the axle module or test object to be tested, more powerful or less powerful loading motors can be arranged on the test stand and controlled by inverters in each case adapted to the power categories of the loading motors.

### BRIEF DESCRIPTION OF THE DRAWINGS

Below, examples of the invention are explained with reference to embodiments illustrated in the figures, which show:

FIG. 1: A schematically represented example of a possible embodiment of a (test stand) according to the invention for testing an electrically drivable axle module for a motor vehicle, and

FIG. 2: A schematically represented side view of an example of a possible embodiment of the first loading motor as arranged on the first sliding carriage.

### DETAILED DESCRIPTION

The same objects, functional units and comparable components are denoted by the same indexes in both figures. As regards their technical characteristics these objects, functional units and comparable components are made identically unless otherwise specified explicitly or implicitly in the description.

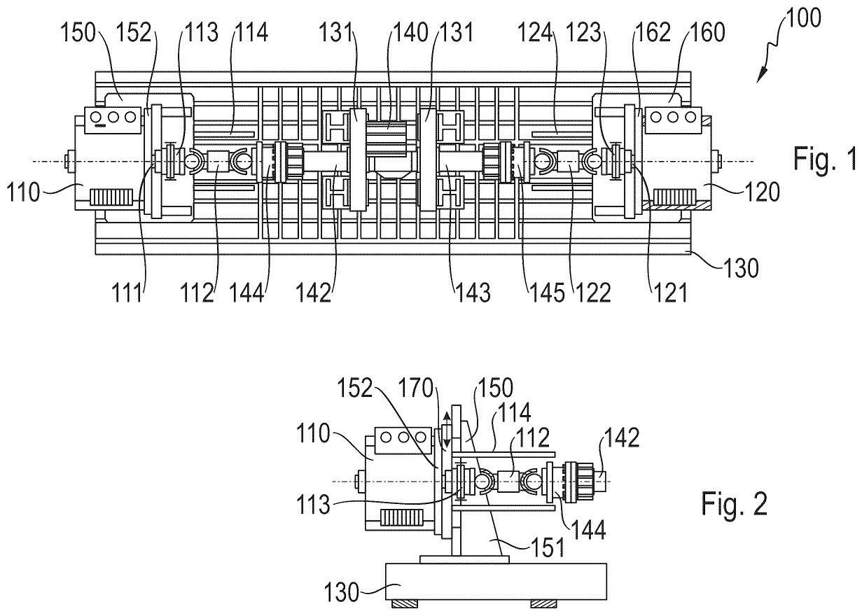

FIG. 1 shows a schematically represented example of a possible embodiment of a test stand 100 according to the invention for testing an electrically drivable axle module 140 for a motor vehicle (not shown in FIG. 1). The test stand 100 comprises a first loading motor 110 and a second loading motor 120 as well as a test stand base 130. The test stand base 130 comprises a test object holder 131 for receiving the axle module 140. The axle module 140 is the test object to be tested.

The axle module 140 in this example consists of an electric drive motor 141, a transmission and two wheel shafts 142, 143. In the representation shown as FIG. 1, in this example the wheel shafts 142, 143 are accommodated in a solid axle housing. Likewise, however, it would also be possible to test an axle module 140 provided for a single wheel suspension, which would then correspondingly have no solid axle housing.

At the axial ends of the wheel shafts 142, 143 wheel rims 144, 145 are mounted. The wheel shafts 142, 143 constitute the drive output shafts 142, 143 of the axle module 140.

A first motor shaft 111 of the first loading motor 110 is connected, without any transmission ratio and no clutch, only by means of a first universal joint shaft 112 to the first drive output shaft 142 and the first wheel rim 144 of the axle module 140. Correspondingly, a second motor shaft 121 of the second loading motor 120 is connected, without any transmission ratio and no clutch, only by means of a second universal joint shaft 122 to the second drive output shaft 143 and the second wheel rim 145 of the axle module 140.

As can be seen, however, the first motor shaft 111 is not connected directly to the first universal joint shaft 112, but rather, the connection is formed by way of a first torque sensor 113 that connects the first motor shaft 111 to the first universal joint shaft 112. Thus, all the torques delivered by the first loading motor 110 to the universal joint shaft 112 pass via the first torque sensor 113 and can be detected by it. Analogously, a second torque sensor 124 is arranged between the second motor shaft 121 and the second universal joint shaft 122.

The first universal joint shaft 112 is surrounded by first mechanical protection means 114, in particular so that operators of the test stand 100 are protected against injury that could be caused owing to the high rotation speeds and high torques of the first loading motor. In the same way, the second universal joint shaft 122 is surrounded by second mechanical protection means 124 to protect operators of the test stand 100 against injury.

The first loading motor 110 and the second loading motor 120 are each in the form of permanently excited synchronous motors 110, 120 with at least twelve magnetic pole pairs. Such synchronous motors 110, 120 are also known as so-termed synchro-torque motors, which are especially compact and in particular axially short and slow-rotating but which can deliver a large torque. In this example the first and second loading motors 110, 120 can rotate at speeds up to 3,000 rpm.

As can be seen, the first loading motor 110 is arranged on a first sliding carriage 150 and the second loading motor 120 is arranged on a second sliding carriage 160. The first sliding carriage 150 and the second sliding carriage 160 can be moved along a rail (not shown in FIG. 1) in the direction toward the axle module 140. This simplifies the mounting of the axle module 140.

In this case the first sliding carriage 150 is in the form of a first clamping angle made of steel and the second sliding carriage 160 is in the form of a second clamping angle also made of steel.

The first sliding carriage 150 comprises a motor holder 152 in the form of a flange connection for the first loading motor 110. Correspondingly, the second sliding carriage 160 comprises a motor holder 162 in the form of a flange connection for the second loading motor 120.

By means of the first motor holder 152 the first loading motor 110 is held with an end, namely the so-termed a-side, adjacent to the motor holder 152 of the first sliding carriage 150. Analogously, the second loading motor 120 is held with an end, namely again with it's a-side, adjacent to the motor holder 162 of the second sliding carriage 160. This enables a comparatively firm connection of the first and second loading motors 110, 120 to the test stand 100.

In a further example embodiment not illustrated in the figures, the axle module 140 of FIG. 1 has no drive motor of its own. Instead, the test stand 100 according to the invention comprises for example a drive motor which, like the two loading motors 110, 120, is in the form of a permanently excited synchronous motor with at least twelve magnetic pole pairs. The drive motor of the test stand is arranged in a T-configuration in such a way relative to the two loading motors 110, 120 that it is perpendicular to a notional axis through the two loading motors 110, 120 and its motor shaft can be connected by way of a universal joint shaft to an input shaft of the axle module 140.

Thus, the axle module 140 can be driven by the drive motor for a testing process and loaded by the loading motors 110, 120.

FIG. 2 shows, as an example and schematically, a side view of a possible embodiment of the first loading motor 110 in a condition as mounted on the first sliding carriage 150. In this case the first loading motor 110 is arranged with it's a-side on the first sliding carriage 150, and between the first sliding carriage 150 and the first loading motor 110 there is a module 170 for vertical adjustment. The vertical adjustment module 170 is arranged with a first side on the first sliding carriage 150 and with a second side against the a-side of the first loading motor 110. In this example the vertical adjustment module 170 correspondingly comprises the motor holder 152 for the first loading motor 110. The vertical adjustment module 170 enables vertical adjustment, i.e., a height adjustment, of the first loading motor 110 arranged on the second side of the vertical adjustment module 170 relative to the first sliding carriage 150 arranged on the first side of the vertical adjustment module 170. In that way the first loading motor 110 can be moved vertically to a position which allows as straight a connection as possible between the first motor shaft 111 and the first drive output shaft 142 of the axle module 140. The universal joint shaft 112 then only needs to compensate a small angular offset.

As can also be seen, the first sliding carriage 150 is in the form of a first clamping angle 150 made of steel and is arranged so that it can move axially along a rail (not shown) over the test stand base 130. As can also be seen, the first sliding carriage also comprises a stiffening brace 151 in order to avoid the occurrence of vibrations as much as possible.

According to a further example embodiment the electric motor shown in FIG. 2 is the second loading motor 120, which is arranged on the second sliding carriage 160.

In still another example embodiment the electric motor shown in FIG. 2 is the drive motor, which is arranged on a sliding carriage assigned to the drive motor.

### INDEXES

100 Test stand
110 First loading motor
111 First motor shaft
112 First connecting shaft, first universal joint shaft
113 First torque sensor
114 First mechanical protection means
120 Second loading motor
121 Second motor shaft
122 Second connecting shaft, second universal joint shaft
123 Second torque sensor
124 Second mechanical protection means
130 Test stand base
131 Test object holder
140 Test object
141 Electric drive motor of the test object
142 First drive output shaft, first wheel shaft
143 Second drive output shaft, second wheel shaft
144 First wheel rim
145 Second wheel rim
150 First sliding carriage, first clamping angle
151 Stiffening brace
152 Motor holder, flange connection
160 Second sliding carriage, second camping angle
162 Motor holder, flange connection
170 Vertical adjustment module

1. A test stand (100) for testing an electrically drivable axle module (140) for a motor vehicle, the axle module having an input shaft, a first drive output shaft (142), and a second drive output shaft (143), the test stand comprising:
at least a first loading motor (110) with a first motor shaft (111);
a second loading motor (120) with a second motor shaft (121);
a test stand base (130) with a test object holder (131) configured for holding the axle module (140), a first sliding carriage (150), and a second sliding carriage (160);
wherein the first motor shaft (111) of the first loading motor (110) can be connected with no transmission ratio to the first drive output shaft (142) of the axle module (140) and the second motor shaft (121) of the second loading motor (120) can be connected with no transmission ratio to the second drive output shaft (143) of the axle module (140), and
wherein the first loading motor (110) and the second loading motor (120) are each in the form of permanently excited synchronous motors with at least twelve magnetic pole pairs,
wherein the first loading motor (110) is arranged on the first sliding carriage (150) on the test stand base (130) and can be moved toward the axle module (140) and the second loading motor (120) is arranged on the second sliding carriage (160) on the test stand base (130) and can be moved toward the axle module (140).

2. The test stand (100) according to claim 1, further comprising a drive motor having a drive motor shaft configured to be connected to the input shaft of the axle module (140).

3. The test stand (100) according to claim 1, wherein the first sliding carriage (150) is in the form of a first clamping angle (150) and the second sliding carriage (160) is in the form of a second clamping angle (160).

4. The test stand (100) according to claim 1, wherein the first sliding carriage has a first motor holder (152) and the second sliding carriage has a second motor holder (162), the first loading motor (110) arranged with an end adjacent to the first motor holder (152) and the second loading motor (120) is arranged with an end adjacent to the second motor holder (162).

5. The test stand (100) according to claim 1, further comprising a vertical adjustment module (170) configured for adjusting the first loading motor (110) and/or for the second loading motor (120) and/or for the drive motor.

6. The test stand (100) according to claim 1, wherein the first motor shaft (111) is connected by way of a first connecting shaft (112), without any transmission ratio and rotationally fixed, to the first drive output shaft (142) and the second motor shaft (111) is connected by way of a second connecting shaft (122), without any transmission ratio and rotationally fixed, to the second drive output shaft (143).

7. The test stand (100) according to claim 1, wherein the first motor shaft (111) is connected rotationally fixed by way of a first torque sensor (113) to the first connecting shaft (112) and the second motor shaft (121) is connected rotationally fixed by way of a second torque sensor (123) to the second connecting shaft (122).

8. The test stand (100) according to claim 7, wherein the first connecting shaft (112) is in the form of a universal joint shaft (112) and the second connecting shaft (122) is in the form of a universal joint shaft (122).

9. The test stand (100) according to claim 7, wherein the first motor shaft (111) is in the form of a hollow shaft and the first torque sensor (113) is arranged at an end of the first loading motor (110) facing away from the axle module (140), and/or the second motor shaft (212) is in the form of a hollow shaft and the second torque sensor (123) is arranged at an end of the second loading motor (120) facing away from the axle module (140).

10. (canceled)

11. The test stand (100) according to claim 8, wherein the first motor shaft (111) is in the form of a hollow shaft and the first torque sensor (113) is arranged at an end of the first loading motor (110) facing away from the axle module (140), and/or the second motor shaft (212) is in the form of a hollow shaft and the second torque sensor (123) is arranged at an end of the second loading motor (120) facing away from the axle module (140).

12. A modular system for the simple production of a test-object-adapted test stand (100) according to claim 1, the modular system comprising:
at least a first loading motor (110) and a second loading motor (120), the first and second loading motors each from a common power category;
a first inverter and a second inverter, the first and second inverters each from a common power category;
a test stand base (130);
a first sliding carriage (150);
a second sliding carriage (160);
wherein the common power category of the at least first and second inverters corresponds to the common power category of the at least first and second electric motors (110, 120).
